(19) United States
(12) Patent Application Publication
(10) Pub. No.: US 2026/0146121 A1
(43) Pub. Date: May 28, 2026

(54) CURABLE AND CURED THERMOSETTING COMPOSITIONS

(71) Applicant: 3M INNOVATIVE PROPERTIES COMPANY, St. Paul, MN (US)

(72) Inventors: Erik M. Townsend, South St. Paul, MN (US); Claire Hartmann-Thompson, Lake Elmo, MN (US); Gregory P. Sorenson, Maplewood, MN (US); Phillip D. Hustad, St. Paul, MN (US); Ralph R. Roberts, Oakdale, MN (US); Mark J. Pellerite, Woodbury, MN (US); Michael W. Kobe, Lake Elmo, MN (US); Mario A. Perez, Wellington, FL (US)

(21) Appl. No.: 19/124,185

(22) PCT Filed: Oct. 16, 2023
(86) PCT No.: PCT/IB2023/060427

§ 371 Date: Apr. 24, 2025

Related U.S. Application Data
(60) Provisional application No. 63/382,600, filed on Nov. 7, 2022.

(51) Int. Cl. C08F 255/02; C08K 5/14; C08K 5/3417

(52) U.S. Cl. CPC C08F 255/026; C08K 5/14; C08K 5/3417

(57) ABSTRACT

Curable thermosetting compositions and cured thermoset compositions are provided. The thermoset compositions can be prepared to have a low coefficient of thermal expansion (CTE) in the range of 0 to 100 degrees Celsius, a low dielectric constant (e.g., less than 2.5), a low dielectric loss tangent (e.g., less than 0.004 at 10 GHz), or a combination thereof. The curable thermosetting compositions contain an addition polymerized polynorbornene copolymer, a bismaleimide resin with a high level of hydrocarbon content, and a thermal radical initiator.

### BACKGROUND

Some components of integrated circuit packaging require curable films that can be thermally laminated onto substrates and then cured in place at elevated temperatures (e.g., 180 to 200 degrees Celsius) to form a thermoset composition with a high glass transition temperature (e.g., greater than 110 degrees Celsius). Although epoxy resins can be used to provide desirable thermosetting materials, they often have a dielectric constant and a dielectric loss tangent (i.e., dissipation factor (Df) that are unacceptably high. Alternative thermosetting compositions are desired, particularly in the integrated circuit (IC) packaging space.

### SUMMARY

Curable thermosetting compositions and cured thermoset compositions are provided. The thermoset compositions can be prepared to have a low coefficient of thermal expansion (CTE) in the range of 0 to 100 degrees Celsius, a low dielectric constant (e.g., less than 2.5), a low dielectric loss tangent (e.g., less than 0.004), or a combination thereof. The curable thermosetting compositions contain an addition polymerized polynorbornene copolymer, a bismaleimide resin with a high level of hydrocarbon content, and a thermal radical initiator.

In a first aspect, a curable composition is provided. The curable composition comprises curable components comprising (a) an addition polymerized polynorbornene copolymer having norbornene monomeric units with pendent crosslinkable groups, (b) a bismaleimide compound, and (c) a thermal radical initiator. The bismaleimide compound, which is present in an amount equal to at least 5 weight percent (e.g., in a range of 5 to less than 80 weight percent) based on the total weight of the curable components, contains (1) two bismaleimide groups and (2) at least one C36 hydrocarbon group with 0 to 3 carbon-carbon double bonds.

In a second aspect, a cured composition is provided. The cured composition comprises a cured reaction product of the curable composition described in the first aspect after exposure to a temperature sufficient to activate the thermal initiator.

In a third aspect, a first article is provided. The first article comprises a substrate and a layer of the curable composition described in the first aspect adjacent to the substrate.

In a fourth aspect, a second article is provided. The second article comprises a layer of the cured composition and an optional substrate, wherein the cured composition is the same as described in the second aspect.

The terms “a”, “an”, and “the” are used interchangeably with “at least one” to mean one or more of the elements being described. The phrases “at least one of” and “comprises at least one of” followed by a list refers to any one of the items in the list and any combination of two or more items in the list.

The term “and/or” means either or both. For example, the expression X and/or Y means X, Y, or a combination thereof (both X and Y).

The term “alkyl” refers to a monovalent group that is a radical of an alkane and includes groups that are linear, branched, cyclic, bicyclic, or a combination thereof. Unless otherwise indicated, the alkyl groups typically contain from 1 to 40 or 1 to 20 carbon atoms. In some embodiments, the alkyl groups contain 1 to 10 carbon atoms, 2 to 10 carbon atoms, 1 to 6 carbon atoms, 2 to 6 carbon atoms, 1 to 4 carbon atoms, or 2 to 4 carbon atoms. Cyclic alkyl groups and branched alkyl groups have at least three carbon atoms. Examples of alkyl groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “alkylene” refers to a divalent group that is a radical of an alkane and includes groups that are linear, branched, cyclic, bicyclic, or a combination thereof. Unless otherwise indicated, the alkylene groups typically contain from 2 to 40 carbon atoms. In some embodiments, the alkylene groups contain 2 to 36 carbon atoms, 2 to 30, 2 to 20, 2 to 10, 2 to 8, 2 to 6, 2 to 4, 3, or 2 carbon atoms. Cyclic alkylene groups and branched alkylene groups have at least three carbon atoms. Examples of alkylene groups include, but are not limited to, methylene, ethylene, n-propylene, n-butylene, n-pentylene, isobutylene, t-butylene, isopropylene, n-octylene, n-heptylene, ethylhexylene, cyclopentylene, cyclohexylene, cycloheptylene, adamantylene, norbornylene, and the like.

The term “alkene” refers to a hydrocarbon compound with a carbon-carbon double bond and includes compounds that are linear, branched, cyclic, bicyclic, or a combination thereof. In some embodiments, the double bond is at the terminal position of a linear or branched compound and the alkene can be of formula CH₂=CH—R where R is an alkyl group. In other embodiments, the alkene includes a cyclic or bicyclic group, and the carbon-carbon double bond is in the cyclic or bicyclic portion of the compound. Although the alkene can have multiple carbon-carbon double bonds, these compounds are not aromatic.

The term “alkenyl” refers to a monovalent radical of an alkene.

The term “alkylidene” refers to a divalent radical of a terminal alkene wherein the radical is connected to an adjacent atom through a carbon-carbon double bond.

The term “arylene” refers to a divalent group that is a radical of an aromatic carbocyclic compound. The arylene group has at least one aromatic carbocyclic ring and can have 1 to 3 optional rings that are connected to or fused to the aromatic carbocyclic ring. The additional rings can be aromatic, aliphatic, or a combination thereof. The arylene group usually has 5 to 20 carbon atoms or 6 to 10 carbon atoms.

The term “curable” refers to a composition or component that can be cured. The terms “cured” and “cure” refer to joining polymer chains together by covalent chemical bonds to form a polymeric network. A cured polymeric network is generally characterized by insolubility, but it may be swellable in the presence of an appropriate solvent. The curable composition typically includes the polynorbornene copolymer, the bismaleimide compound, the thermal activator, and any other optional components.

The term “curable components” refers to those materials within the curable composition that are involved in the curing reaction. The curable components are typically the polynorbornene copolymer, the bismaleimide compound, and the thermal activator. This term does not include any optional components.

The term “(hetero)hydrocarbon” refers to a hydrocarbon and/or a hetero-hydrocarbon. The term “hydrocarbon” refers to refers to a compound or group having only carbon and hydrogen atoms. The term “hetero-hydrocarbon” refers to a compound or group having carbon, hydrogen, and heteroatoms. Heteroatoms typically include nitrogen, oxygen, and sulfur. The terms “(hetero)hydrocarbyl”, “hydrocarbyl”, and “hetero-carbyl” refer to groups having a valency of one. The terms “(hetero)hydrocarbylene”, “hydrocarbylene”, and “hetero-carbylene” refer to groups having a valency of two.

As used herein, the term “norbornene-based monomer” refers to a compound of formula

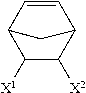

where each X¹ and X² is independently hydrogen or a substituent such as, for example, an alkyl or a crosslinkable group containing a carbon-carbon double bond. The term “norbornene monomer” refers to a subset of the compound of the above formula where both X¹ and X² are hydrogen. The chemical structures of substituted norbornene-based compounds are intended to encompass all exo/endo isomers as well as all enantiomers/diastereomers that would be consistent with the represented atom connectivity.

As used herein, the term “norbornene-based monomeric unit” refers to a group of formula

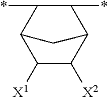

where each X¹ and X² is independently hydrogen or a substituent such as, for example, an alkyl or a crosslinkable group containing a carbon-carbon double bond. The term “norbornene monomeric unit” refers to a subset of the group of the above formula where both X¹ and X² are hydrogen. The asterisk (*) indicate the attachment sites to other monomeric units such as other norbornene monomeric units and/or terminal groups in the copolymer.

As used herein, the term “polymerizable composition” refers to the composition used to form the polynorbomene copolymer. It includes, for example, the various types of norbornene-containing monomers as well the catalyst or pro-catalyst/activator, optional 1-alkenes, optional Lewis bases, and any other optional materials such as solvents and the like.

The terms “polymer” and “polymeric material” are used interchangeably and refer to materials formed by reacting one or more monomers. The terms include homopolymers, copolymers, terpolymers, and the like. Likewise, the terms “polymerize” and “polymerizing” refer to the process of making a polymeric material that can be a homopolymer, copolymer, terpolymer, and the like. The terms “polymer” and “copolymer” can be used interchangeably when the polymeric material includes more than one type of monomeric unit.

As used herein, any statement of a range includes the endpoint of the range and all suitable values within the range (e.g., 1 to 5 includes 1, 1.5, 2, 2.75, 3, 3.80, 4, 5, etc.).

As used herein, the term “room temperature” refers to a temperature of 20 to 30 degrees Celsius such as 20 to 25, 22 to 25, or 23 degrees Celsius.

Dashes on both side of groups such as —O—, —NH—, and —(C═O)—O— indicate that these groups are divalent. A dash on a single side of a group such as —(C═O)—OH indicates that this group is monovalent.

### DETAILED DESCRIPTION

Curable and cured compositions are provided that include an addition polymerized polynorbomene copolymer. Further, articles containing the curable or cured compositions or provided. The cured compositions are thermoset resins that can be used in various applications such as for integrated circuit packaging. The cured compositions are formed from a curable composition that includes curable components comprising (a) an addition polymerized polynorbomene copolymer having norbornene-based monomeric units with pendent crosslinkable groups, (b) a bismaleimide compound in an amount equal to at least 5 weight percent (e.g., in a range of 5 to less than 80 weight percent) based on a total weight of the curable components, and (c) a thermal radical initiator. The bismaleimide compound has (1) two bismaleimide groups and (2) at least one C36 hydrocarbon group with 0 to 3 carbon-carbon double bonds. The at least one C36 hydrocarbon group in the bismaleimide compound is typically aliphatic but can include a single aromatic ring.

### Curable Composition

The curable composition includes curable components that include an addition polymerized polynorbornene copolymer, a bismaleimide compound functioning as a crosslinker for the addition polymerized polynorbornene, and a thermal radical initiator. Each curable component is described below.

### Addition Polymerized Polynorbornene Copolymer

The polynorbornene copolymer is an addition polymerized reaction product of a plurality of different norbornene-based monomers. The polymerizable composition used to form the polynorbornene copolymer includes at least one norbornene-based monomer that has a pendent crosslinkable group. Other norbornene-based monomers are often further included in the polymerizable composition such as those that have a pendent hydrocarbon group such as, for example, an alkyl group. Additionally, norbornene monomers (i.e., without any pendent groups) can be included. The various monomers are polymerized in the presence of a catalyst that typically includes a Group 10 element of the periodic table of elements.

Any suitable norbornene-based monomer having a pendent crosslinkable group can be used. As used herein, the term “crosslinkable group” refers to a group that can react when heated in the presence of the thermal radical initiator. The crosslinkable group typically contains a reactive carbon-carbon double bond.

In some embodiments, the norbornene-based monomer having a pendent crosslinkable group is of Formula (I)

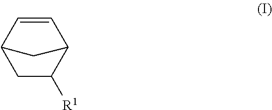

where the pendent group R¹ is an alkenyl or alkylidene group. The alkenyl or alkylidene group can have 2 or more carbon atoms such as, for example, 2 to 10 carbon atoms. The number of carbon atoms can be at least 2, at least 3, or at least 4 and up to 10, up to 8, up to 6, or up to 4 carbon atoms. Examples of the norbornene-based monomer of Formula (I) are of Formula (I-A) or (I-B).

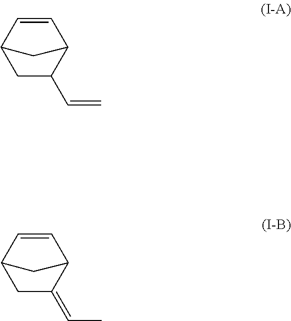

These monomers are commercially available, for example, from Millipore-Sigma and TCI America.

In other embodiments, the norbornene-based monomer having a pendent crosslinkable group is of Formula (II).

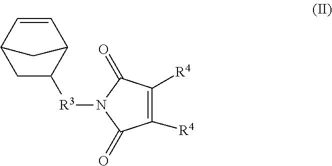

In the monomers of Formula (II), the crosslinkable group is the carbon-carbon double bond of the maleimido group. Group R³ can be any suitable (hetero)hydrocarbon group. Each group R⁴ is typically hydrogen or methyl. In many embodiments, both R⁴ groups are hydrogen, or one R⁴ group is methyl while the other is hydrogen.

In many embodiments, R³ is an alkylene such as those having 1 to 40 carbon atoms. The number of carbon atoms is at least 1, at least 2, at least 3, or at least 5 carbon atoms and up to 40, up to 35, up to 30, up to 25, up to 20, up to 15, up to 10, up to 8, up to 6, or up to 4 carbon atoms. For example, R³ can be an alkylene that has 1 or 2 carbon atoms. Where R³ is an alkylene, the monomers of Formula (II) can be prepared by reacting a norbornene-containing compound (1) having a pendent —R³—NH₂ group with a maleic anhydride (2) as shown below in Reaction Scheme A.

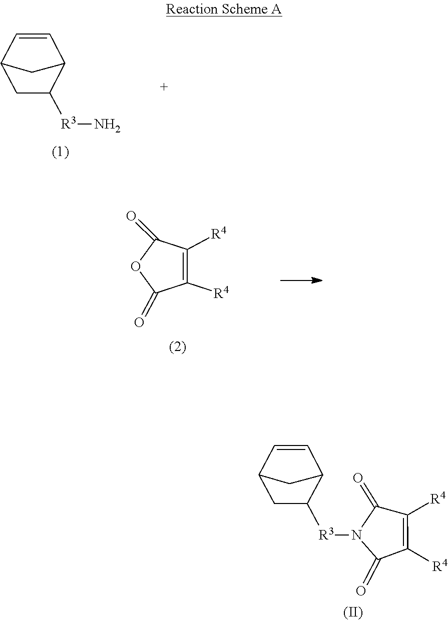

The groups R³ and R⁴ are the same as defined above. In some examples, R³ is methylene or ethylene and each R⁴ is independently hydrogen or methyl. Compounds (1) and (2) are commercially available, for example, from Millipore-Sigma.

In other embodiments, R³ in Formula (II) is a divalent group of formula —R⁵—NH—(C═O)—R⁶— where R⁵ and R⁶ are each an alkylene group with R⁵ being equal to —(CH₂)ₓ— and R⁶ being equal to —(CH₂)_{y}—. This compound can be formed as shown in Reaction Scheme B.

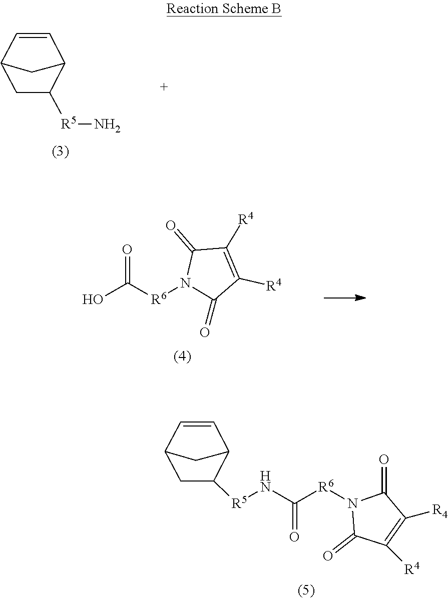

More particularly, compound (5) is the condensation reaction of compounds (3) and (4) in the presence of heat. Compound (3) contains a group R⁵ that is an alkylene of formula —(CH2)ₓ— with the variable x being an integer in a range of 1 to 20. Compound (4) contains a group R⁶ that is an alkylene of formula —(CH₂)_{y}— with y being an integer in a range of 1 to 20. The variables x and y can be independently at least 1, at least 2, at least 3, at least 4, at least 6, or at least 8 and up to 20, up to 18, up to 16, up to 12, up to 10, up to 8, up to 6, up to 5, up to 4, or up to 3.

In still other embodiments, the group R³ in Formula (II) is a divalent group of formula

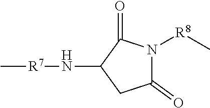

where R⁷ is an alkylene of formula —(CH₂)_{q}— and R⁸ is a hydrocarbylene. The variable q is an integer in a range of 1 to 20 such as at least 1, at least 2, at least 3, at least 4, at least 6, or at least 8 and up to 20, up to 18, up to 16, up to 12, up to 10, up to 8, up to 6, up to 5, up to 4, or up to 3. They hydrocarbylene R⁸ can be saturated or unsaturated and can be linear, cyclic, or a combination thereof. The cyclic group can be saturated or unsaturated and can include, for example, one or more alkylene groups. Group R⁸ often includes at least 6, at least 8, at least 10, at least 12, at least 16, or at least 20 carbon atoms and up to 40, up to 36, up to 30, up to 24, up to 20, up to 18, up to 16, or up to 10 carbon atoms. These groups can be formed, for example, by a condensation reaction such as shown below in Reaction Scheme C by reacting a compound (6) with a compound (7) to form compound (8).

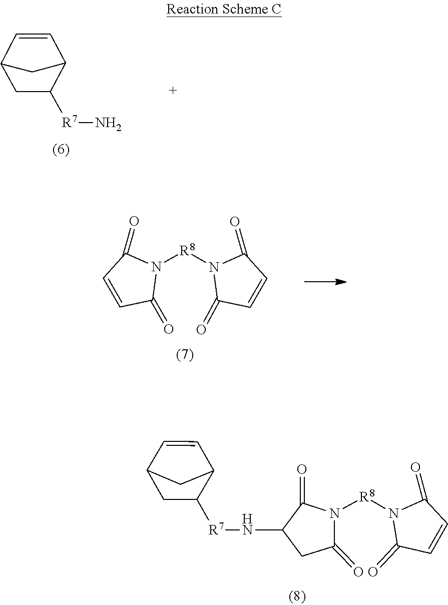

Compound (7) can be formed, for example, by reaction of a diamine of formula H₂N—R—NH₂ with maleic anhydride. In some embodiments, the compound H₂N—R—NH₂ is a dimer diamine where R⁸ is a hydrocarbylene group with 36 carbon atoms. The hydrocarbylene contains 0 to 3 carbon-carbon double bonds. That is, R⁸ is —C₃₆—H₆₉—, —C₃₆H₇₀—, —C₃₆—H₇₁—, or —C₃₆H₇₂—. In other embodiments, the diamine of formula H₂N—R—NH₂ used to form compound 7 includes a R⁸ with one or more aromatic groups. For example, R⁸ can be a group of formula —Ar—R²—Ar— wherein each Ar is an arylene such as phenylene and R² is an alkylene having 1 to 6 carbon atoms. The alkylene can have at least 1, at least 2, at least 3 and up to 6, up to 4, or up to 3 carbon atoms. In some examples, R² is methylene (—CH₂—) or propylene (—C(CH₃)₂—).

The polymerizable composition typically contains 2 to 80 mole percent of the crosslinking monomer (i.e., a monomer of Formula (I-A), (I-B), (II), or a mixture thereof) based on the total moles of the norbomene-based monomers. Within this range, higher amounts tend to produce a cured composition having a desirably low coefficient of thermal expansion, but both the dielectric constant and the dielectric loss undesirably tend to increase. The amount of the crosslinking monomer is often optimized based on the desired properties of the cured composition. The amount can be at least 2, at least 5, at least 10, at least 20 weight percent, at least 30, at least 40, or at least 50 and up to 80, up to 75, up to 70, up to 65, up to 60, up to 65, up to 60, up to 50, up to 45, up to 40, up to 30, or up to 35 mole percent based on the total moles of the norbomene-based monomers.

In addition to the crosslinking monomer, other norbomene-based monomers are often included in the polymerizable composition used to form the polynorbornene copolymer. For example, the polymerizable composition often includes norbomene-based monomers that have a pendent hydrocarbyl group such as, for example, an alkyl group. Such monomers can be of Formula (III) where R⁹ is an alkyl.

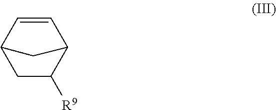

The alkyl can have any suitable number of carbon atoms, but it often contains 1 to 40 carbon atoms. The number of carbon atoms can be at least 1, at least 2, at least 3, at least 4, or at least 6 and up to 40, up to 36, up to 30, up to 20, up to 18, up to 16, up to 12, up to 10, up to 8, or up to 6 carbon atoms. In some embodiments, there are at least 4 or 6 and up to 10 carbon atoms.

The amount of the monomer of Formula (III) can be in a range of 0 to 90 mole percent, 10 to 90 mole percent, or 20 to 90 mole percent based on the total moles of norbornene-based monomers. The amount of this monomer is often at least 20, at least 25, at least 30, at least 35, or at least 40 mole percent and can be up to 90, up to 84, up to 80, up to 75, up to 70, up to 65, up to 60, up to 55, up to 50, up to 45, or up to 40 mole percent based on the total moles of norbornene-based monomers.

In some embodiments, the polynorbornene copolymer is prepared from a polymerizable composition that further includes norbornene-based monomers without any substituent groups (i.e., norbornene). Norbornene is often added to increase the glass transition temperature (Tg) of the polynorbornene copolymer. As a homopolymer, it has a Tg near 300 degrees Celsius. However, the solubility of the homopolymer in many common solvents tends to be quite low, so the norbornene-based monomers of Formula (III) are typically added in a higher amount than norbornene. The amount of norbornene without any substituent group can be in a range of 0 to 50 mole percent. The amount is often at least 1, at least 2, at least 3, at least 4, or at least 5 mole percent and up to 50, up to 40, up to 30, up to 25, up to 20, up to 15, up to 10, or up to 5 mole percent based on the total moles of norbornene-based monomers.

The polymerizable composition used to form the polynorbornene copolymer often includes 2 to 80 mole percent crosslinking monomers such as those of Formula (I), (IB), or (II), 20 to 90 mole percent monomer with a pendent alkyl group such as those of Formula (III), and 0 to 50 mole percent norbornene. The amount is based on the total moles of norbornene-based monomers. In some embodiments, the polymerizable composition contains 5 to 75 mole percent crosslinking monomers, 25 to 85 mole percent monomers with a pendent alkyl group, and 1 to 25 mole percent norbornene. In still other embodiments, the polymerizable composition contains 10 to 60 mole percent crosslinking monomers, 25 to 80 mole percent monomers with a pendent alkyl group, and 5 to 20 mole percent norbornene. In yet other embodiments, the polymerizable composition contains 10 to 50 mole percent crosslinking monomers, 30 to 80 mole percent monomers with a pendent alkyl group, and 5 to 10 mole percent norbornene.

The polymerizable composition used to form the polynorbornene copolymer can further include compounds having an ethylenically unsaturated group such as a 1-alkene compound that is miscible with the norbornene-based monomers. The 1-alkene compound is typically added to control the molecular weight of the resulting polynorbornene copolymer but usually is not incorporated or incorporated only to a small extent into the polymeric structure. For example, typically greater than 98 weight percent of the 1-alkene monomer does not get enchained into the polynorbornene copolymer. That is, less than 2 weight percent, less than 1 weight percent, or less than 0.5 weight percent of the 1-alkene gets enchained. Suitable 1-alkene monomers include, but are not limited to, those having 6 to 18 carbon atoms such as 1-hexene, 1-heptene, 1-octene, 1-decene, 1-dodecene, or the like. If a monomer with fewer than 6 carbon atoms is used, it may be too volatile at temperatures commonly used for the polymerization reaction such as near 70 degrees Celsius.

The polymerizable composition used to form the polynorbornene copolymer often contains 0 to 60 weight percent of the 1-alkene monomer based on the total weight of the polymerizable composition. The amount of the 1-alkene can be 0, at least 5, at least 10, at least 15, at least 20, at least 25, or at least 30 and up to 60, up to 55, up to 50, up to 45, up to 40 weight percent.

The polynorbornene copolymer is polymerized using an addition polymerization process. As used herein, the term “addition polymerization” (also sometimes referred to in the art as vinyl-addition polymerization) refers to a polymerization process involving an olefin coordination-insertion pathway mediated by an organometallic catalyst. This process is distinguished from a common alternative polymerization method, Ring-opening Metathesis Polymerization (ROMP), both in mechanism and reaction product. ROMP polymers contain double bonds in the polymer backbone, whereas addition polymers according to the present disclosure do not. The addition polymerization reaction usually occurs at or near room temperature over a period of several hours.

A great many addition polymerization catalysts are known in the art and are typically based on organometallic catalysts comprising Ti, Zr, Cr, Co, Fe, Cu, Ni, Pt, or Pd. Of these, addition polymerization catalysts comprising Ni or Pd are commonly used. There is voluminous literature on organometallic addition polymerization catalysts, and especially for norbornene-type monomers. Generally, the active catalyst species is a cationic transition metal complex that has an alkyl or allyl ligand and a weakly coordinating anion. The addition polymerization catalyst may include a single active species (or a combination thereof) or it may be provided as a precursor combination of a pro-catalyst and an activator. Generally, the pro-catalyst provides the active site for the olefin insertion mechanism that forms the addition polymer. Combination with the activator converts the pro-catalyst into its active form.

In some embodiments, appropriate catalyst(s) or pro-catalyst/activator combinations for the addition polymerization of cycloolefins include a Group 10 (i.e., of the Periodic Table of the Elements) catalyst or pro-catalyst/activator combinations. The Group 10 catalyst such as those that are Ni-based, Pd-based, or Pt-based can include a ring structure such as one having a single carbon-carbon double bond. Alternatively, late metal (e.g., Ni- or Pd-based) pro-catalysts can have allyl/alkyl ligands as well as chloride ligands. These pro-catalysts are activated by the addition of monovalent metal (Li, Na, Ag) salts of weakly coordinating anions (e.g., BF₄, tetrakis(3,5-bis(trifluoromethyl)phenyl)borate (BARF), or perfluorotetraphenylborate). Typically, the molar ratio of activator to pro-catalyst is in the range of 10:1 to 1:10 such as in the range of 10:1 to 1:1, although other ratios may also be used.

Many useful addition polymerization catalysts and pro-catalyst/activator combinations are known and are disclosed, for example, in col. 8, line 28 to column 9 line 56 of U.S. Pat. No. 3,330,815 (McKeon et al.); column 3, line 9 to column 17, line 16 of U.S. Pat. No. 6,455,650 B1 (Lipian et al.); column. 3, line 18 to column 31, line 53 of U.S. Pat. No. 6,825,307 (Goodall); column 3, line 31 to column 17, line 16 of U.S. Pat. No. 6,903,171 B2 (Rhodes et al.); and column 16, line 32 to column 28, line 31 of U.S. Pat. No. 7,759,439 B2 (Rhodes et al.); column 20, line 28 to column 21, line 30 in U.S. Pat. No. 10,266,720 (Burgoon et al.); and paragraphs [0015] to [0075] of U.S. Pat. Appl. Publ. 2005/0187398 A1 (Bell et al.), the disclosures of which are incorporated herein by reference. Details concerning certain addition polymerization catalysts are also reported by M. V. Bermeshev and P. P. Chapala in “Addition polymerization of functionalized norbornenes as a powerful tool for assembling molecular moieties of new polymers with versatile properties”, Progress in Polymer Science (2018), 84, pp. 1-46.

Addition of a Lewis base, which coordinately bonds to the metal atom, may improve the activity of addition polymerization catalysts and/or pro-catalysts. The Lewis base is typically bonded to the metal atom by sharing both of its lone pair of electrons. Any Lewis base known in the art can be used for this purpose. Preferably, the Lewis base can dissociate readily under the polymerization conditions. In some embodiments, the Lewis base is a phosphine-containing compound such as, for example, tricyclohexylphosphine.

Many different combinations of pro-catalyst, activator, and Lewis base, or catalyst and Lewis base, can be used in the catalyst solution used to prepare the addition polymerized polynorbornene copolymer. In some embodiments, a pro-catalyst is used and the pro-catalyst is a palladium-containing compound (e.g., Pd is the Group 10 element), the activator is a boron-containing salt, and the Lewis base is a phosphorus-containing compound. For example, a combination of allyl[1,3-bis(2,6-diisopropylphenyl)imidazol-2-ylidene]chloropalladium(II) as the pro-catalyst, sodium tetrakis[3,5-bis(trifluoromethyl)phenyl]borate as the activator, and tricyclohexylphosphine as the Lewis base can be used for the addition polymerization of the norbornene-based monomers.

Any suitable molar ratio of the norbomene-based monomers to the Group 10 element can be used. In some embodiments, the ratio can be up to 2000:1, up to 2500:1, up to 3000:1, up to 5000:1, up to 10,000:1, or even up to 20,000:1.

The polynorbornene copolymer often has a weight average molecular weight (Mw) in a range of 10 to 1000 kiloDaltons (kDa). The Mw is often at least 10, at least 20, at least 25, at least 50, or at least 100 kDa and can be up to 1000, up to 500, up to 200, or up to 100 kDa. The Mw can be measured by Size Exclusion Chromatography (SEC).

The polynorbornene copolymer often has a glass transition temperature (Tg) in a range of 80 to 280 degrees Celsius. The Tg can be at least 80, at least 100, at least 120, or at least 150 and up to 280, up to 260, up to 250, up to 220, up to 200, up to 180, up to 160, or up to 150 degrees Celsius. The Tg can be determined from the peak in the tan(delta) curve obtained using Dynamic Mechanical Analysis as described in the Examples section.

The curable components of the curable composition typically contain 20 to 95 weight percent polynorbornene copolymer based on the total weight of the curable components, which includes the polynorbornene copolymer, the bismaleimide compound, and the thermal radical initiator. The amount can be at least 20, at least 25, at least 30, at least 35, at least 40, at least 45, at least 50, at least 55, or at least 60 and up to 95, up to 90, up to 85, up to 80, up to 75, up to 70, up to 65, up to 60, up to 55, up to 50, up to 45, or up to 40 weight percent polynorbornene copolymer.

### Bismaleimide Compound

The polynorbornene copolymer is reacted with a bismaleimide compound to form the cured composition. The bismaleimide compound includes two maleimido groups and at least one C36 hydrocarbon group that has 0 to 3 carbon-carbon double bonds. These C36 groups typically have 69, 70, 71, or 72 hydrogen atoms. Although these groups are typically predominantly aliphatic some C36 groups include a single 6-membered aromatic ring. In some embodiments, there are at least two or more C36 groups.

Generally, crosslinkers tend to decrease the coefficient of thermal expansion of the cured composition. While this is a desirable feature, many crosslinkers tend to increase the dielectric constant (Dk) and the dielectric loss tangent (Df). For use of the cured composition in the preparation of integrated circuit packaging systems, both a low dielectric constant and a low dielectric loss tangent are desired. Surprisingly, the bismaleimide crosslinkers having at least one C36 group with 0 to 3 carbon-carbon double bonds tend to decrease both the dielectric constant and the dielectric loss tangent relative to other common crosslinkers. Thus, using these bismaleimide crosslinkers advantageously can result in the formation of cured compositions with low dielectric constant (e.g., Dk less than 2.5) and low dielectric loss tangent (Df less than 0.004 while at the same time reducing the coefficient of thermal expansion in the temperature range of 0 to 100 degrees Celsius. The frequency used to measure both the dielectric constant and the dielectric loss tangent is often in a range of 5 to 50 GHz such as at least 5, at least 10, at least 15, at least 20 and up to 50, up to 40, up to 30, up to 15, or up to 10 GHz.

In some embodiments, the bismaleimide compound has a single C36 hydrocarbon group. The number of carbon-carbon double bonds can be 0, 1, 2, or 3. An example of such a compound is shown below with no carbon-carbon double bonds but other similar compounds having 1, 2, or 3 carbon-carbon double bonds could be used as well. These compounds are formed by reaction of a dimer diamine with maleic anhydride.

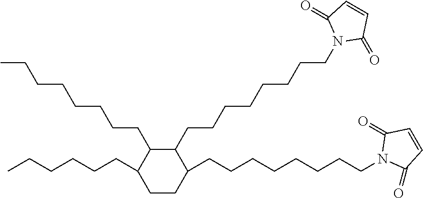 [SMILES: CCCCCCCCC1C(CCCCCC)CCC(CCCCCCCCN2C(=O)C=CC2=O)C1CCCCCCCCN1C(=O)C=CC1=O]

Isomers of any of these compounds can also be used. The compound above is commercially available from Designer Molecules, Inc. (San Diego, CA, USA) under the trade designation BMI-689.

In other embodiments, the bismaleimide has two or more C36 groups with each having 0 to 3 carbon-carbon double bonds. These compounds are often formed as shown in Reaction Scheme D.

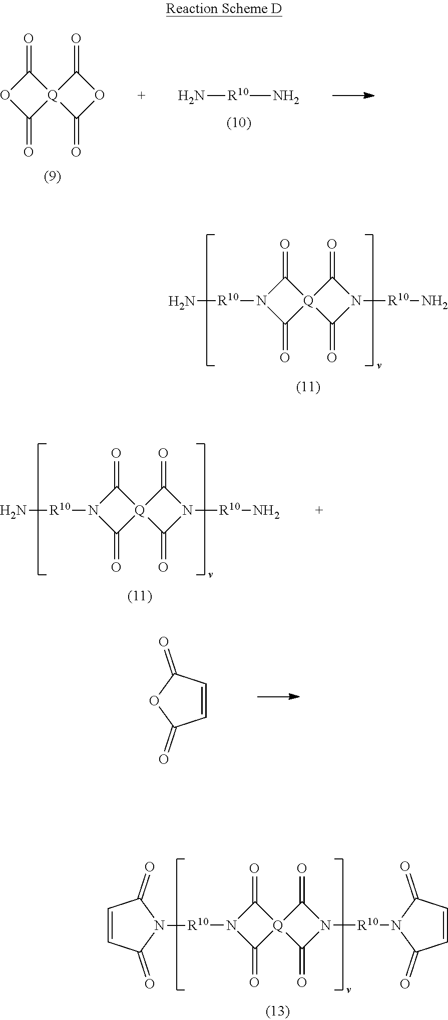

In this reaction scheme that is not shown as being balanced, excess dimer diamine of formula H₂N—R¹⁰—NH₂ (compound (10)) is initially reacted with a compound having two anhydride groups such as that shown as compound (9) to form an intermediate that is compound (11). The variable v in compound (11) is in a range of 1 to 10 such as 1 to 8, 1 to 6, 1 to 5, 1 to 4, or 1 to 3. Compound (10) is typically a dimer diamine. Thus, each group R¹⁰ is typically a C36 group having 0 to 3 carbon-carbon double bonds (i.e., having 69 to 72 hydrogen atoms). In compound (9), group Q is any linking group that is bonded to two anhydride groups. Group Q often includes at least one aromatic ring.

In some embodiments, group Q has a single aromatic ring, and that ring is fused to two anhydride groups as in compound (9-1).

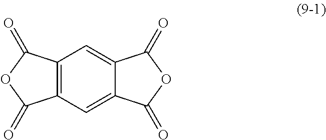 [SMILES: O=c1oc(=O)c2cc3c(=O)oc(=O)c3cc12]

In other embodiments, group Q includes two or more aromatic rings with an aromatic group fused to each maleic anhydride group as in compounds (9-2), (9-3), and (9-4).

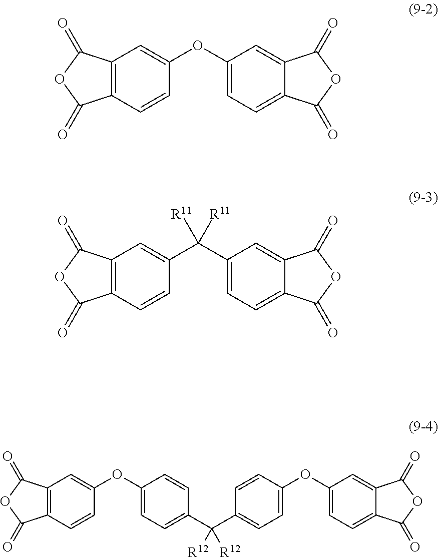

Each R¹ and R¹² is independently hydrogen, methyl, or trifluoromethyl.

Intermediate compound (11) in Reaction Scheme D is then reacted with maleic anhydride to form bismaleimide compound (13). The bismaleimides that are formed using compounds (9-1), (9-2), (9-3), and (9-4) are shown below as bismaleimide compounds (13-1) to (13-4).

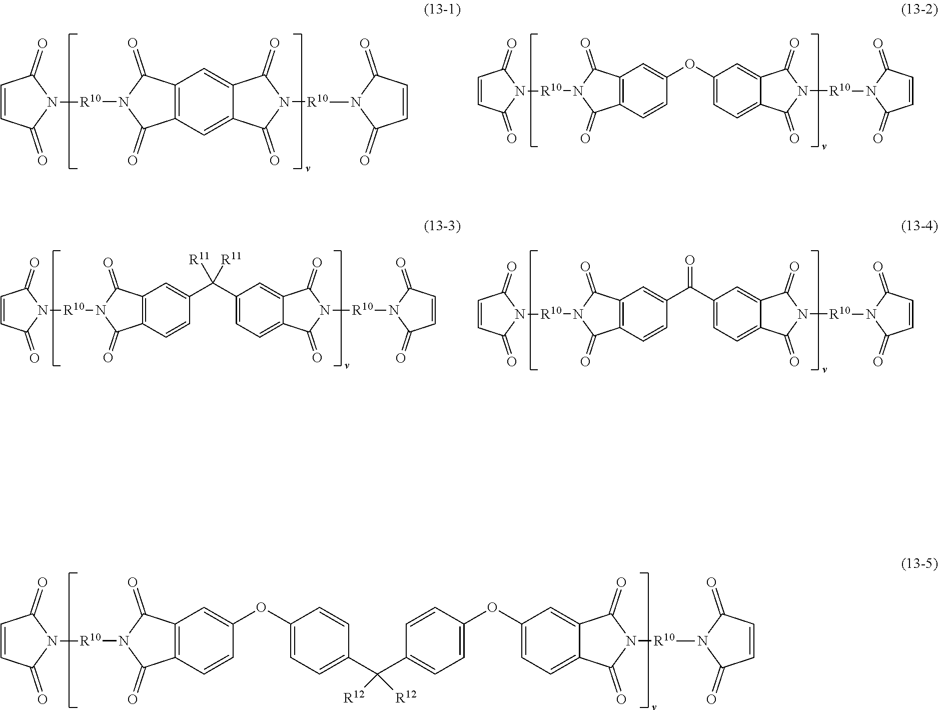

A compound (13-1) is commercially available from Designer Molecules, Inc. (San Diego, CA, USA) as BMI-3000 with R¹⁰ being a C36 group with 0 carbon-carbon double bonds and with v having a value in a range of 1 to 10 with the average often being about 3. A compound (13-2) is commercially available from Designer Molecules, Inc as BMI-1500 with R¹⁰ being a C₃₆H₇₀ group and v having an average value of about 1.3. A compound (13-4) is commercially available from Designer Molecules, Inc. as BMI-1550. A compound (13-5) is commercially available from Designer Molecules, Inc. as BMI-1400 with v being in a range of 1 to 10. Other similar compounds may also be available from Designer Molecules, Inc.

The curable components of the curable mixture typically contain at least 5 weight percent of the bismaleimide compound having at least one C36 group with 0 to 3 carbon-carbon double bonds based on the total weight of the curable components, which includes the poly(norbornene) copolymer, the bismaleimide compound, and the thermal radical initiator. The amount can be, for example, in a range of 5 to 80 weight percent or 5 to less than 80 weight percent based on the total weight of the curable components. This amount can be at least 5, at least 10, at least 15, at least 20, at least 25, at least 30, at least 35, or at least 40 weight percent and up to or less than 80, up to or less than 75, up to 70, up to or less than 65, up to or less than 60, up to 55, up to or less than 50, up to or less than 45, or up to or less than 40 weight percent. The amount of the bismaleimide used tends to be high compared to the amount of many common crosslinkers used in similar curable compositions.

### Thermal Radical Initiator

Suitable thermal radical initiators include various azo compounds such as those commercially available under the trade designation VAZO from Chemours Co. (Wilmington, DE, USA) including VAZO 67, which is 2,2′-azobis(2-methylbutane nitrile), VAZO 64, which is 2,2′-azobis(isobutyronitrile), VAZO 52, which is (2,2′-azobis(2,4-dimethylpentanenitrile), and VAZO 88, which is 1,1′-azobis(cyclohexanecarbonitrile); various peroxides such as benzoyl peroxide, cyclohexane peroxide, lauroyl peroxide, di-tert-amyl peroxide, tert-butyl peroxy benzoate, di-cumyl peroxide, and peroxides commercially available from Atofina Chemical, Inc. (Philadelphia, PA, USA) under the trade designation LUPERSOL (e.g., LUPERSOL 101, which is 2,5-bis(tert-butylperoxy)-2,5-dimethylhexane, and LUPERSOL 130, which is 2,5-dimethyl-2,5-di-(tert-butylperoxy)-3-hexyne); various hydroperoxides such as tert-amyl hydroperoxide, tert-butyl hydroperoxide, and cumene hydroperoxide; and mixtures thereof.

The amount of the thermal radical initiator is often in a range of 0.01 to 5 weight percent based on the total weight of the curable components, which includes the polynorbornene copolymer, the bismaleimide compound, and the thermal radical initiator. The amount can be at least 0.01, at least 0.05, at least 0.1, at least 0.2, at least 0.5, or at least 1 weight percent and up to 5, up to 4, up to 3, up to 2, up to 1, or up to 0.5 weight percent.

### Optional Components in the Curable Composition

Other optional components can be present in the curable composition in addition to the curable components. Suitable optional components include, but are not limited to, adhesion promoters, fillers that can be organic materials, inorganic or ceramic materials, or combinations thereof. Suitable optional additives include, but are not limited to, fillers, stabilizers, flow control agents, cure rate retarders, adhesion promoters, impact modifiers, expandable microspheres, glass beads or bubbles, thermally conductive particles, electrically conductive particles, glass, clay, pigments, colorants, antioxidants, and the like. Any of these additives can be added in any suitable amount.

### Curable Composition and Article Containing the Curable Composition

The curable composition contains 20 to 95 weight percent polynorbomene copolymer, 5 to 79.99 (e.g., less than 80) weight percent bismaleimide compound, and 0.01 to 5 weight percent thermal initiator based on the total weight of the curable components in the curable composition. In some embodiments, the curable composition contains 30 to 90 weight percent polynorbomene copolymer, 10 to 69.99 (e.g., less than 70) weight percent bismaleimide compound, and 0.01 to 5 weight percent thermal initiator based on the total weight of the curable components. In other embodiments, the curable composition contains 40 to 84.5 weight percent polynorbomene copolymer, 15 to 60 weight percent bismaleimide compound, and 0.5 to 3 weight percent thermal initiator based on the total weight of the curable components. In still other embodiments, the curable composition contains 50 to 80 weight percent polynorbomene copolymer, 20 to 49 weight percent bismaleimide compound, and 1 to 3 weight percent thermal initiator based on the total weight of the curable components. In yet other embodiments, the curable composition contains 65 to 80 weight percent polynorbomene copolymer, 20 to 34 weight percent bismaleimide compound, and 1 to 3 weight percent thermal initiator based on the total weight of the curable components.

In many embodiments, the curable composition is applied as a layer to a suitable first substrate or release liner. If desired, a roll-to-roll process can be used to apply a layer of the curable composition on the first substrate. Often, the curable composition contains an organic solvent that is removed by evaporation at room temperature or at an elevated temperature such as in a range of 40 to 120 degrees Celsius.

After removal of any solvent from the curable composition, the curable composition layer can be rolled with the first substrate or release liner. Alternatively, a second substrate can be positioned adjacent to a second surface of the curable composition layer opposite the first substrate. In some embodiments, the first and/or second substrates are both selected so that the curable composition does not adhere strongly, and each substrate can be removed later. In some embodiments, the curable composition is positioned between two different substrates and then rolled. Although both substrates can be removed later, the adhesion strength to the two substrates is often selected to be different so that one substrate is more easily removed than the other.

Any suitable substrate can be used as the first or second substrate mentioned above. These substrates can be flexible or inflexible and can be electrically conductive or non-conductive. The substrates can be formed from a polymeric material, glass, ceramic material, metal (including various alloys), or combination thereof. In some embodiments, the substrate is glass, a ceramic material, or metal. Suitable polymeric materials can be selected from a polymeric film or a plastic composite (e.g., glass or fiber filled plastics). The polymeric material can be prepared, for example, from polyolefins (e.g., polyethylene, polypropylene, or copolymers thereof), polyurethanes, polyvinyl acetates, polyvinyl chlorides, polyesters (polyethylene terephthalate or polyethylene naphtholate), polycarbonates, polymethyl(meth)acrylates (PMMA), ethylene-vinyl acetate copolymers, and cellulosic materials (e.g., cellulose acetate, cellulose triacetate, and ethyl cellulose). A non-conductive substate can be coated with a conductive layer, if desired.

Release liners can be used in the manufacture of the articles and function as temporary substrates. That is, the release liners are replaced with permanent substrates. Suitable release liners typically have low affinity for the curable composition. Exemplary release liners can be prepared from paper (e.g., Kraft paper) or other types of polymeric material. Some release liners are coated with an outer layer of a release agent such as a silicone-containing material or a fluorocarbon-containing material (e.g., polyfluoropolyether or polytetrafluoroethylene).

### Cured Composition

The cured composition is formed by heating the curable composition at a temperature sufficient to crosslink the polynorbornene copolymer with the bismaleimide compound. Suitable temperatures are often in a range of 150 to 200 degrees Celsius.

If the curable composition is in the form of a roll, the roll is typically unrolled, and the curable composition is heated to crosslink the polynorbornene copolymer with the bismaleimide compound. If there is a single substrate, this substrate may be present during the curing process for support. The single substrate may be thermally laminated to the cured composition or may be removable leaving a cured film. Alternatively, the curable composition can be separated from the first substrate and positioned next to yet another substrate (e.g., third substrate) before curing and be thermally laminated to the third substrate during the curing process.

If there are two substrates (e.g., a first and a second substrate) in the roll, one substrate (the first substrate) is typically removed before curing or before positioning the curable composition adjacent to yet another substrate (i.e., a third substrate). If the curable composition is positioned adjacent to the third substrate, the second substrate may be removed after positioning the curable composition and before curing. If the curable composition is not positioned adjacent to a third substrate, curing often occurs while the curable composition is in contact with the second substrate. In such embodiments, the second substrate may be removed after curing to provide a film of the cured composition.

The cured composition can be used, for example, in the integrated packaging space. Cured films can have a combination of desirable properties such as a high glass transition temperature (e.g., greater than 110 or greater than 120 degrees Celsius and up to 300 or up to 275 degrees Celsius), a low coefficient of thermal expansion (e.g., less than 100 ppm for an unfilled system), between 0 and 100 degrees Celsius; a low dielectric constant (e.g., Dk less than 2.5), and a low dielectric loss tangent (Df less than 0.004).

### Examples

Unless otherwise noted or apparent from the context, all parts, percentages, ratios, etc. in the Examples and the rest of the specification are by weight. Table 1, below, lists materials used in the examples and their sources.

TABLE 1
Table of Materials

| Designation | Description | Source |
|---|---|---|
| BMI-1500 | bismaleimide resin obtained as | Designer Molecules, Inc. |
| | BMI-1500 that has at least one | [San Diego, CA, USA] |
| | C36 group | |
| BMI-1971 | bis(3-ethyl-5-methyl-4- | TCI America [Portland, OR, |
| | maleimidophenyl)methane | USA] |
| BMI-3000 | bismaleimide resin obtained as | Designer Molecules, Inc. |
| | BMI-3000 CG that has at least | |
| | one C36 group | |
| BMI-689 | bismaleimide resin obtained as | Designer Molecules, Inc. |
| | BMI-689 that has at least one | |
| | C36 group | |
| DCE | 1,2-dichloroethane | Alfa Aesar [Ward Hill, MA, |
| | | USA] |
| DCP | dicumyl peroxide | MilliporeSigma [Burlington, |
| | | MA, USA] |
| Dimethylmaleic anhydride | dimethylmaleic anhydride | Oakwood Chemical [Estill, |
| | | SC, USA] |
| DMMAINB | 1-(bicyclo[2.2.1]hept-5-en-2- | Synthesized as described in |
| | ylmethyl)-3,4-dimethyl-1H- | the Synthetic Procedures |
| | pyrrole-2,5-dione | below. |
| DNB | 5-decyl-2-norbornene | Wiley Companies |
| | | [Coshocton, OH, USA] |
| HNB | 5-hexyl-2-norbornene | Synthesized as described in |
| | | the literature: Designed |
| | | Monomers and Polymers, |
| | | Vol. 8, No. 3, pp. 237-248 |
| | | (2005). |
| ENB | 5-ethylidene-2-norbornene, | Alfa Aesar [Ward Hill, MA, |
| | mixture of endo and exo isomers | USA] |
| MEK | methyl ethyl ketone | MilliporeSigma |
| Na(BARF)₄ | sodium tetrakis[3,5- | Alfa Aesar [Ward Hill, MA, |
| | bis(trifluoromethyl)phenyl]borate | USA] |
| NB | 2-norbornene | Alfa Aesar |
| 5-Norbornene-2- | 5-norbornene-2-methylamine, | TCI America [Portland, OR, |
| methylamine | approximately 80:20 mixture of | USA] |
| | exo:endo isomers | |
| 1-octene | 1-octene | Alfa Aesar |
| PCy₃ | tricyclohexylphosphine | Alfa Aesar |
| Pd(iDipp)(allyl)Cl | allyl[1,3-bis(2,6- | Strem Chemicals |
| | diisopropylphenyl)imidazol-2- | [Newburyport, MA, USA] |
| | ylidene]chloropalladium(II) | |
| Toluene | toluene | MilliporeSigma |
| VNB | 5-vinyl-2-norbornene | TCI America [Portland, OR, |
| | | USA] |

### Test Methods

### Size Exclusion Chromatography (SEC)

The average molecular weight for each of the polynorbomene copolymers was measured using size exclusion chromatography (SEC). The SEC equipment consisted of a 1260 Infinity 11 liquid chromatography system (comprised of isocratic pump, autosampler, column compartment and variable wavelength UV/visible detector) from Agilent Technologies (Santa Clara, CA) operated at a flow rate of 1.0 mL/minute. The SEC column set was comprised of two PLgel 5 um MIXED-C (300 millimeters (mm) length×7.5 mm internal diameter) and a PLgel 5 um guard column (50 millimeters (mm) length×7.5 mm internal diameter) all from Agilent Technologies. The detection consisted of a mini-DAWN 3 angle Light Scattering detector and an OPTILAB differential refractive index detector, both from Wyatt Technology Corporation (Santa Barbara, CA). Data were collected and analyzed using software ASTRA version 8 from Wyatt Technology Corporation. The column compartment, UV/vis detector, and differential refractive index detector were set to 40° C. The solvent and eluent (or mobile phase) consisted of tetrahydrofuran (stabilized with 250 parts per million of butylated hydroxytoluene) OMNISOLV grade from EMD Millipore Corporation, Burlington, MA. Briefly, polymer solutions were prepared by dissolving approximately 50 mg of polymer in 10 mL of the eluent, tetrahydrofuran, targeting a polymer solution concentration of 5 mg per mL. Polymer solutions were loaded into the SEC equipment using autosampler and an injection volume of 50 microliters. Number average molecular weight (Mₙ), weight average molecular weight (M_{w}), and polydispersity index (D) were calculated with software ASTRA version 8 using the signal from the OPTILAB differential refractive index detector and a dn/dc value of 0.1300.

### Dynamic Mechanical Analysis (DMA)

Dynamic mechanical analysis was performed on a TA Instruments RSA-G2 (TA Instruments [TA Instruments, Eden Prairie, MN]) with a temperature ramp at constant strain using the following method steps: 1) Equilibrate at −30° C.; 2) Ramp 3° C./min to 300° C. Parameters: sampling interval 10 s/point; strain=0.1%. For each film sample to be tested, a rectangular piece was cut (approximate dimensions: 6.5 mm×50 mm, thickness recorded individually). The gas used to purge, heat, and cool the chamber was nitrogen.

### Thermomechanical Analysis (TMA)

Thermomechanical analysis was performed on a TA Instruments Q400 TMA. at a temperature ramp using the following method steps: 1) Equilibrate at −20° C.; 2) Isothermal for 2 min; 3) Ramp 2° C./min to 300° C., 4) Isothermal for 2 min; 5) Ramp 2° C./min to −20° C., 6) Ramp 2° C./min to 300° C.; 7) Isothermal for 2 min. Probe: Expansion; Preload force=0.250 N. For each film sample to be tested, a rectangular piece was cut (approximate dimensions: 6.5 mm×9.0 mm, thickness recorded individually). The coefficient of thermal expansion (CTE) was obtained by examining the slope of the dimensional change vs temperature curve and expressed as a ppm/° C. value. This CTE data was obtained only from the second heating cycle (Step 6 from the above method). The gas used to purge, heat, and cool the chamber was nitrogen.

### Split Post Dielectric Resonator Measurements

All split-post dielectric resonator measurements were performed in accordance with the standard IEC 61189-2-721, at 10.1 GHz and 25° C. Each material was inserted between two fixed dielectric resonators. The resonance frequency and quality factor of the posts are influenced by the presence of the specimen, and this enables the direct computation of complex permittivity (dielectric constant and dielectric loss). The geometry of the split dielectric resonator fixture used in our measurements was designed by the Company QWED in Warsaw Poland. These resonators operate with the TE01d mode which has only an azimuthal electric field component so that the electric field remains continuous on the dielectric interfaces. The split post dielectric resonator measures the permittivity component in the plane of the specimen. Loop coupling (critically coupled) was used in each of these dielectric resonator measurements. This Split Post Resonator measurement system was combined with Keysight VNA (Vector Network Analyzer Model PNA N5222B along with millimeter-wave test set model N5292A, 900 Hz-110 GHz). Computations were performed with the commercial analysis Split Post Resonator Software of QWED to provide a powerful measurement tool for the determination of complex electric permittivity of each specimen at the testing frequency, which was 10 GHz.

### Synthetic Procedures

### Preparation of 1-(Bicyclo[2.2.1]hept-5-en-2-ylmethyl)-3,4-dimethyl-1H-pyrrole-2,5-dione (DMMAINB)

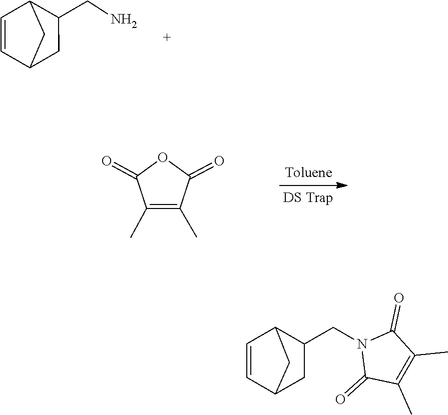

The method was adapted from that given in Example M1 of U.S. Pat. No. 8,053,515 (Elce et al.). A 500 ml 2-neck round bottom (2NRB) flask was equipped with magnetic stirring, oil bath heat, and a dropping funnel. The flask was charged with 22.6 g (0.18 moles) dimethylmaleic anhydride and 200 ml toluene, and then immersed in an oil bath at 35° C. The anhydride dissolved completely to give a clear solution. Under a nitrogen blanket, 22.2 g (0.18 moles) of 5-norbornene-2-methylamine was added with stirring via the addition funnel. A colorless solid began precipitating immediately with the first drop of amine. The vial that contained the amine charge was washed with two 10 ml portions of toluene that were also pipetted into the addition funnel and added dropwise to the reaction mixture. After addition was complete, the reaction mixture was a solid mass although the stir bar was still turning. The flask was transferred to an oil bath at 80° C., the addition funnel was replaced with a Dean-Stark (DS) trap topped with reflux condenser, and the oil bath temperature was ramped to 140° C. (set point). Toluene reflux started after about 30 min, and the reaction mass began to break up. Reflux was continued for 6 hours, then the oil bath temperature was turned down to 75° C. and the apparatus was left overnight. Upon return, about 3.2 g (99% yield) of water was recovered from the trap, including large droplets adhering to the trap wall. The apparatus was disassembled, and the flask was removed from the oil bath and allowed to cool after capping with glass stoppers. The toluene solution of the crude reaction mixture was washed twice with 50 mL portions of 1 M KOH solution to remove traces of starting anhydride, then four times with deionized water. The solution was dried over anhydrous MgSO₄ and filtered through Whatman #4 filter paper into a 1 L round bottom (RB) flask. Solvent was removed by rotary evaporation followed by nitrogen flush to leave 37.7 g crude product as a light brown liquid. Vacuum distillation of 36.4 g this material in a 250 ml Microware RB flask using a Kugelrohr apparatus gave 36.2 g (87% isolated yield) clear, colorless distillate at 140-165° C. and 1-2 torr. ¹H and ¹³C NMR spectra in CDCl₃ solution showed the distillate to be of extremely high purity, with no non-solvent related peaks visible other than those assigned to the desired product.

### Preparation of Catalyst Solution C1

The following components were combined in a small glass jar with a magnetic stir bar and stirred for at least 30 minutes at room temperature before being added to a reaction mixture as described in the synthetic procedure for Polymer P3: 68.7 milligrams (mg) Pd(iDipp)(allyl)Cl, 67.3 mg PCy₃, 531.7 mg Na(BArF)₄, and 75.36 grams (g) DCE.

### Preparation of Catalyst Solution C2

The following components were combined in a 25 mL screw-cap glass jar with a magnetic stir bar and stirred for at least 30 minutes at room temperature before being added to a reaction mixture as described in the synthetic procedure for Polymers P1, P2, P4, P5, P6, P7, and P8: 23.1 milligrams (mg) Pd(iDipp)(allyl)Cl, 22.9 mg PCy₃, 177.9 mg Na(BArF)₄, and 25.30 grams (g) DCE. For synthetic procedures aside from Polymer P3, an appropriate amount of Catalyst Solution C2 was made using the same molar proportions of catalyst components and method such that once added to the monomer solutions, the molar ratio of total norbornene-type monomers to Palladium was 5000 to 1.

### Preparation of Copolymer P1

A 500 mL three-neck round-bottomed reactor was loaded with ENB (2.40 g, 17.6 mmol), DNB (42.20 g, 180.0 mmol), 1-octene (22.44 g, 200.0 mmol), and toluene (87.77 g, 952.6 mmol). The reactor was fitted with a reactor head containing a nitrogen gas inlet, over-head mechanical stirring apparatus (glass rod and PTFE blade), and one port was sealed with a rubber septum. The assembly was placed in a water bath equilibrated to 23° C., stirred at 400 rpm, and purged with nitrogen for 30 minutes. The Catalyst Solution C2 was added to the reaction mixture quickly via a 20 mL polypropylene syringe with an 18-gauge needle. The reaction was stirred for 24 hours. After this time, the mixture had built significant viscosity and had turned a translucent brown color. ¹H NMR analysis of the crude reaction mixture showed that all the reactive double bonds of the monomers had disappeared. The reaction mixture was slowly poured into a 4000-mL beaker containing −2000 mL of MEK with mechanical stirring. White stringy polymer precipitated as the mixture was poured. After all the reaction solution was added the precipitated solids were broken up and cut with scissors to aid with stirring. The polymer was allowed to stir for at least two hours to fully precipitate from the reaction solution. The polymer was isolated via vacuum filtration using a Buchner funnel and filter paper. The isolated polymer solids were dried in an open aluminum pan at ambient temperature for at least 18 hours followed by 90° C. forced air oven for 2 hours. The isolated yield of Polymer P1 was 44.34 g (99.42% yield based on total norbornene-type monomers added). The weight average molecular weight was 403.8 kg/mole and the polydispersity index was 2.80.

### Preparation of Copolymer P2

The polymer was synthesized in the same manner as Polymer P1 using HNB (32.10 g, 180.0 mmol), DMMAINB (4.64 g, 20.1 mmol), 1-octene (22.44 g, 200.0 mmol), toluene (106.20 g, 1152.6 mmol), and Catalyst Solution C2 containing 23.9 milligrams (mg) Pd(iDipp)(allyl)Cl, 22.7 mg PCy₃, 177.2 mg Na(BArF)₄, and 25.30 grams (g) DCE. The polymerization was allowed to proceed for 48 hours before precipitation due to the slower reaction of the DMMAINB monomer. Isolation and drying of the polymeric product were accomplished as in Polymer P1. The isolated yield of Polymer P2 was 26.78 g (72.93% yield based on total norbornene-type monomers added). The weight average molecular weight was 251.7 kg/mole and the polydispersity index was 2.02.

### Preparation of Copolymer P3

The following components were added to a 1000-mL multi-neck reaction vessel equipped with an overhead mechanical stirrer: NB (25.42 g, 270 mmol), DNB (63.29 g, 270 mmol), ENB (7.21 g, 60 mmol), 67.33 g 1-octene, and 294.46 g toluene. The headspace of the vessel was flushed with nitrogen for 5 minutes, after which time 76.02 g of Catalyst Solution C1 was added via pipet. The vessel was capped and stirred at room temperature for 20.5 hours. After this time, the mixture had built significant viscosity and had turned a translucent brown color. ¹H NMR analysis of the crude reaction mixture showed that nearly all the reactive double bonds of the monomers had disappeared. Half of the reaction mixture was slowly poured into a 4000-mL beaker containing about 2000 mL of MEK with magnetic stirring. White stringy polymer precipitated as the mixture was poured. Periodically, the strings were broken up and cut with scissors to aid with stirring. More MEK was added during this process up to a total of ˜3000 mL. This pouring/stirring/cutting process was repeated with the other half of the reaction mixture. The polymer strings obtained from this process were washed three times with fresh MEK on a glass filter frit and placed into an aluminum pan. The strings were dried in a 90° C. oven for 2 hours. The isolated yield of Polymer P3 was 91.20 g (95.08% yield based on total norbornene-type monomers added). The weight average molecular weight was 411.1 kg/mole and the polydispersity index was 7.07.

### Preparation of Copolymer P4

The polymer was synthesized in the same manner as Polymer P1 using HNB (16.07 g, 90.13 mmol), NB (8.47 g, 90.0 mmol), DMMAINB (4.63 g, 20.0 mmol), 1-octene (22.44 g, 200.0 mmol), toluene (110.67 g, 1201.1 mmol), and Catalyst Solution C2 containing 22.9 milligrams (mg) Pd(iDipp)(allyl)Cl, 22.7 mg PCy₃, 177.2 mg Na(BArF)₄, and 13.73 grams (g) DCE. The polymerization was allowed to proceed for 48 hours before precipitation due to the slower reaction of the DMMAINB monomer. Isolation and drying of the polymeric product were accomplished as in Polymer P1. The isolated yield of Polymer P4 was 25.36 g (87.00% yield based on total norbornene-type monomers added). The weight average molecular weight was 300.8 kg/mole and the polydispersity index was 2.80.

### Preparation of Copolymer P5

The polymer was synthesized in the same manner as Polymer P1 using DNB (42.20 g, 180.0 mmol), NB (1.88 g, 20.0 mmol), 1-octene (22.44 g, 200.0 mmol), toluene (87.77 g, 952.6 mmol), and Catalyst Solution C2 containing 23.1 milligrams (mg) Pd(iDipp)(allyl)Cl, 22.9 mg PCy₃, 177.9 mg Na(BArF)₄, and 25.08 grams (g) DCE. The polymerization was allowed to proceed for 24 hours before precipitation. Isolation and drying of the polymeric product were accomplished as in Polymer P1. The isolated yield of Polymer P5 was 44.04 g (99.91% yield based on total norbornene-type monomers added). The weight average molecular weight was 267.2 kg/mole and the polydispersity index was 3.48.

### Preparation of Copolymer P6

The polymer was synthesized in the same manner as Polymer P1 using DNB (52.74 g, 225.0 mmol), ENB (9.01 g, 75.0 mmol), 1-octene (33.67 g, 300.0 mmol), toluene (140.63 g, 1526.3 mmol), and Catalyst Solution C2 containing 22.9 milligrams (mg) Pd(iDipp)(allyl)Cl, 34.2 mg PCy₃, 293.9 mg Na(BArF)₄, and 25.30 grams (g) DCE. The polymerization was allowed to proceed for 22 hours before precipitation. Isolation and drying of the polymeric product were accomplished as in Polymer P1. The isolated yield of Polymer P6 was 61.69 g (99.89% yield based on total norbornene-type monomers added). The weight average molecular weight was 405.2 kg/mole and the polydispersity index was 2.49.

### Preparation of Copolymer P7

The polymer was synthesized in the same manner as Polymer P1 using VNB (30.05 g, 250.0 mmol), HNB (44.62 g, 250.3 mmol), 1-octene (112.22 g, 1000.1 mmol), toluene (204.60 g), and Catalyst Solution C2 containing 57.5 milligrams (mg) Pd(iDipp)(allyl)Cl, 57.5 mg PCy₃, 443.3 mg Na(BArF)₄, and 26.52 grams (g) DCE. The polymerization was allowed to proceed for 22 hours before precipitation. Isolation and drying of the polymeric product were accomplished as in Polymer P1. The isolated yield of Polymer P7 was 64.32 g (86.14% yield based on total norbornene-type monomers added). The weight average molecular weight was 116.9 kg/mole and the polydispersity index was 2.35.

### Preparation of Copolymer P8

The polymer was synthesized in the same manner as Polymer P1 using VNB (30.05 g, 250.0 mmol), DNB (58.62 g, 250.1 mmol), 1-octene (112.22 g, 1000.1 mmol), toluene (191.01 g), and Catalyst Solution C2 containing 57.2 milligrams (mg) Pd(iDipp)(allyl)Cl, 56.1 mg PCy₃, 443.1 mg Na(BArF)₄, and 25.30 grams (g) DCE. The polymerization was allowed to proceed for 22 hours before precipitation. Isolation and drying of the polymeric product were accomplished as in Polymer P1. The isolated yield of Polymer P8 was 87.97 g (99.21% yield based on total norbornene-type monomers added). The weight average molecular weight was 155.6 kg/mole and the polydispersity index was 2.84.

### Examples EX1 to EX13 and Comparative Examples CE1 to CE5: Preparation, Curing. and Analysis of Films

Glass jars were equipped with stir bars and charged with the amounts of materials shown in Table 2 below. The resulting solutions were capped and stirred for 16-24 hours at room temperature.

TABLE 2
Components of Examples EX1 to EX13 and Comparative Examples CE1 to CE5

| | Amount (g) | | | | | | | | | | | | | |
|---|---|---|---|---|---|---|---|---|---|---|---|---|---|---|
| | | | | | | | | | BMI- | BMI- | BMI- | BMI- | | |
| Example Solution | P1 | P2 | P3 | P4 | P5 | P6 | P7 | P8 | 689 | 1500 | 3000 | 1971 | DCP | Toluene |
| EX1 | 3.20 | | | | | | | | 0.80 | | | | 0.08 | 36.0 |
| EX2 | | 3.20 | | | | | | | 0.80 | | | | 0.08 | 36.0 |
| EX3 | | | 3.20 | | | | | | 0.80 | | | | 0.08 | 36.0 |
| EX4 | | | | 3.20 | | | | | 0.80 | | | | 0.08 | 36.0 |
| EX5 | | | 3.20 | | | | | | | 0.80 | | | 0.08 | 36.0 |
| EX6 | | | 3.20 | | | | | | | | 0.80 | | 0.08 | 36.0 |
| EX7 | | | | | | 3.20 | | | 0.80 | | | | 0.08 | 36.0 |
| EX8 | | | 3.60 | | | | | | 0.40 | | | | 0.08 | 36.0 |
| EX9 | | | 2.80 | | | | | | 1.20 | | | | 0.08 | 36.0 |
| EX10 | | | | | | | 3.20 | | 0.80 | | | | 0.08 | 36.0 |
| EX11 | | | | | | | | 3.20 | 0.80 | | | | 0.08 | 36.0 |
| EX12 | | | 2.80 | | | | | | | 1.20 | | | 0.08 | 36.0 |
| EX13 | | | 2.80 | | | | | | | | 1.20 | | 0.08 | 36.0 |
| CE1 | | | 3.20 | | | | | | | | | 0.80 | 0.08 | 36.0 |
| CE2 | | | | | 3.20 | | | | 0.80 | | | | 0.08 | 36.0 |
| CE3 | | | 4.0 | | | | | | | | | | 0.08 | 36.0 |
| CE4* | | | | | | | | | 4.0 | | | | 0.08 | 16.0 |
| CE5** | | | 0.40 | | | | | | | | 3.60 | | 0.08 | 36.0 |

CE4* prepared using a different procedure than other examples and comparative examples as explained below.
CE5** prepared using a different procedure than other examples and comparative examples as explained below.

All solutions from Table 2 (except for CE4 and CE5, see description below) were cast into films as follows. About 35 g of the solution was poured into a round glass dish (diameter 90 mm, depth 18 mm). The dish was allowed to sit uncovered in a passively vented cabinet for at least 48 hours at room temperature. During this time, most or all the toluene evaporated. The resulting solid film was dried at 70° C. for one hour. The flat central portion of each dried film was cut out and subjected to the General Procedure for Thermal Curing of Films described below. The appearance and thickness of some of the film samples before and after thermal curing are recorded in Table 3.

The General Procedure for Thermal Curing of Films was conducted as follows. Film samples were sandwiched between polytetrafluoroethylene (PTFE) sheets, which were in turn sandwiched between flat steel plates. These sandwich constructions were heated in a nitrogen-purged furnace using the following heating profile: Step 1) Ramp 5° C./minute from room temperature to 200° C.; Step 2) hold at 200° C. for two hours; and Step 3) turn off heat and allow to return to room temperature. This procedure was modified somewhat for CE4 and CE5 as described below.

CE4 solution (8.63 g) was poured into a shallow rectangular PTFE mold (85 millimeters (mm)×34 mm×4 mm) and allowed to dry at room temperature for 7 days, leaving a layer of thick liquid. It was thermally cured in the oven according to the General Procedure for Thermal Curing of Films, except that it was not placed into a sandwich construction, but rather baked in the same PTFE mold.

CE5 solution (about 35 g) was poured into a round glass dish (diameter 90 mm, depth 18 mm). The dish was allowed to sit uncovered in a passively vented cabinet for at least 48 hours at room temperature. After this time, the material was not a freestanding film, but rather a tough, waxy solid with small crystals. The dish and its contents were placed directly into the nitrogen-purged furnace and treated with the same heating profile described in the General Procedure for Thermal Curing of Films.

TABLE 3
Appearance and Thickness of Film Samples.

| | | Uncured | | |
|---|---|---|---|---|
| Film | Uncured Film | Film | Cured Film | Cured Film |
| Sample | Appearance | Thickness | Appearance | Thickness |
| EX1 | Moderate haze | | Moderate haze | 0.63 mm |
| EX2 | Moderate haze | | Moderate haze | 0.62 mm |
| EX3 | Moderate haze | 0.55 mm | Moderate haze | 0.56 mm |
| EX4 | Moderate haze | | Moderate haze | 0.54 mm |
| EX5 | Mild haze | 0.62 mm | Moderate haze, | 0.64 mm |
| | | | slight yellowing | |
| EX6 | Mild haze | 0.61 mm | Moderate haze, | 0.64 mm |
| | | | slight yellowing | |
| EX7 | Moderate haze | | Moderate haze | 0.68 mm |
| EX8 | Mild haze | | Mild haze | 0.64 mm |
| EX9 | Moderate haze | | Mild haze | 0.64 mm |
| EX10 | Moderate haze | | Moderate haze, | 0.64 mm |
| | | | yellowing | |
| EX11 | Moderate haze, | | Moderate haze, | 0.60 mm |
| | small crystals | | yellowing, | |
| | | | small crystals | |
| EX12 | Mild haze | | Mild haze | 0.73 mm |
| EX13 | Mild haze | | Mild haze | 0.71 mm |
| CE1 | Heavy haze, | 0.50 mm | Heavy haze, | 0.53 mm |
| | small crystals | | small crystals | |
| CE2 | Moderate haze | | Moderate haze | 0.72 mm |
| CE3 | Slight haze | 0.52 mm | Slight haze | 0.58 mm |
| CE4 | Transparent | Still | Transparent | 0.84 mm |
| | yellow | liquid | yellow | |
| CE5 | Waxy solid, | | Clear yellow, | 0.67 mm |
| | small crystals | | small crystals | |

The cured film samples from above were evaluated using the Dynamic Mechanical Analysis method described above. See Table 4 below for storage modulus (E′) results. Tg was calculated by recording the peak in the tan(delta) curve.

TABLE 4
Results of DMA Testing

| Example | E′ @ 30° C. | E′ @ 225° C. | Tg | Ratio of E′ @ 30° C./ |
|---|---|---|---|---|
| Film | (MPa) | (MPa) | (° C.) | E′ @ 225° C. |
| EX1 | 258.93 | 1.33 | 113 | 195 |
| EX2 | 751.53 | 4.75 | 217 | 158 |
| EX3 | 756.95 | 1.64 | 141 | 462 |
| EX4 | 1188.3 | 5.36 | 215 | 222 |
| EX5 | 695.47 | 0.94 | 144 | 740 |
| EX6 | 686.81 | 0.77 | 144 | 892 |
| EX7 | 418.86 | 3.19 | 129 | 131 |
| EX8 | 758.91 | 0.94 | 141 | 807 |
| EX9 | 741.60 | 2.69 | 141 | 276 |
| EX10 | 819.68 | 161.25 | 273 | 5 |
| EX11 | 573.67 | 67.72 | 131 | 8 |
| EX12 | 531.31 | 1.42 | 140 | 374 |
| EX13 | 524.05 | 1.03 | 142 | 504 |
| CE1 | 1115.2 | 4.01 | 158 | 278 |
| CE2 | 222.69 | 0.33 | 95 | 675 |
| CE3 | 826.74 | 0.46 | 145 | 1797 |
| CE4 | 485.58 | 97.20 | 54 | 5 |
| CE5 | 116.85 | 8.19 | 31 | 14 |

Comparing CE3 (formed using P3 with DCP as the crosslinking agent) with its maleimide-augmented counterparts EX3, EX5, and EX6, the ratio of storage moduli at 30° C. and 225° C. is significantly lower when bismaleimide is used for crosslinking. A lower value for this ratio signifies that the material is maintaining its strength and integrity better at higher temperatures, even above the glass transition temperature. Maintaining integrity at high temperature is one of the desirable aspects of a thermoset material. CE1 is also a bismaleimide-augmented formulation of P3, and it also has a low storage modulus ratio. However, CE1 as a material is undesirable because the highly aromatic nature of BMI-1971 that lacks a C36 group renders it poorly compatible with P3 (see the high amount of haze and crystals observed for CE1 in Table 3). CE4 (simply BMI-689+DCP without a polynorbornene copolymer) is a liquid in the uncured state and a very brittle material when cured; these are both undesirable attributes.

Comparing CE2, which contains no crosslinkable groups in the polymer (P5), to analogs which have crosslinkable groups (EX1, EX3, and EX4), the presence of the crosslinkable groups along the polymer work together with the added BMI to create a higher modulus and higher glass transition cured material. In addition, the modulus at temperatures above T_{g}, such as E′ at 225° C., shows that higher crosslink density is achieved with polymerizable groups in the polymer.

The cured film samples from above were subjected to thermal mechanical analysis (TMA) with the results shown in Table 5.

TABLE 5
Results of TMA Testing

| Example | CTE (ppm/° C. | CTE (ppm/° C. | CTE (ppm/° C. |
|---|---|---|---|
| Film | and 0° C.-50° C.) | and 50° C.-100° C.) | and 200° C.-250 C.) |
| EX1 | 414.9 | 504.0 | 568.1 |
| EX2 | 29.4 | 180.9 | 526.9 |
| EX3* | 57.3 | 125.0 | N/A |
| EX4 | 42.8 | 89.0 | 511.8 |
| EX5 | 301.0 | 414.7 | 469.4 |
| EX6 | 404.7 | 510.1 | 591.9 |
| EX7 | 298.0 | 411.8 | 497.5 |
| EX8* | 85.9 | 149.4 | N/A |
| EX9* | 46.3 | 139.8 | N/A |
| EX10* | 117.1 | 121.2 | N/A |
| EX11* | 138.5 | 141.1 | N/A |
| EX12* | 88.7 | 169.8 | N/A |
| EX13* | 67.4 | 152.5 | N/A |
| CE1 | 68.1 | 235.8 | N/A** |
| CE2 | 436.2 | 567.7 | 504.4 |
| CE3 | 371.8 | 478.1 | N/A** |
| CE4 | 114.9 | 178.6 | 183.4 |
| CE5* | 396.5 | 548.1 | N/A |

*These samples were tested using the same instrumentation as described in the TMA test, but the method was slightly different: 1) Equilibrate at −20° C.; 2) Isothermal for 2 min; 3) Ramp 2° C./min to 200° C., 4) Isothermal for 2 min; 5) Ramp 2° C./min to −20° C., 6) Ramp 2° C./min to 200° C.; 7) Isothermal for 2 min.
**The dimensional change vs. temperature curve in this region was not linear or pseudo-linear, so a useful value could not be obtained.

Comparing CE3 (P3+DCP) with its maleimide-augmented counterparts EX3, EX5, and EX6, the CTE is significantly lower when BMI-689 is included, somewhat lower when BMI-1500 is included, but similar when BMI-3000 is included. Like what was seen in the DMA results above, CE1 seems to have an attractively low CTE, but its lack of homogeneity renders it undesirable.

Likewise, CE4 has relatively low CTE values, but its liquid uncured state and brittle cured state are undesirable.

Comparing CE2, which contains no crosslinkable groups in the polymer (P5) to analogs which have crosslinkable groups (EX1, EX3, and EX4), the presence of the crosslinkable groups along the polymer seems to cause a reduction in the CTE of the polymers below the Tg compared to the non-crosslinkable control polymer. Increasing the crosslinkable monomer content in EX7 versus EX1 also decreases the observed CTE for the cured materials.

Comparing CE5, which has a very high level of bismaleimide resin and a very low amount of polynorbornene polymer, with all EX1-EX13 (which have lower amounts of bismaleimide resin and higher amounts of polynorbornene polymer) reveals the advantages of the Example compositions. CE5 did not form a freestanding film in the uncured state, and in the cured state produced a film with a very low Tg, both of which are undesirable.

The data in Table 6 was obtained for the listed examples and comparative examples using Split Post Dielectric Resonator Measurements procedure described above.

TABLE 6
Results of dielectric testing at 10.1 GHz.

| | Dielectric | Dielectric |
|---|---|---|
| Example | Constant (Dₖ) | loss Factor (D_{f}) |
| EX1 | 2.24 | 0.00103 |
| EX2 | 2.34 | 0.00241 |
| EX3 | 2.30 | 0.00178 |
| EX4 | 2.36 | 0.00303 |
| EX5 | 2.34 | 0.00191 |
| EX6 | 2.36 | 0.00184 |
| EX7 | 2.25 | 0.00108 |
| CE1 | 2.25 | 0.00111 |
| CE2 | 2.21 | 0.00092 |
| CE3 | 2.38 | 0.00305 |

1. A curable composition comprising curable components comprising:
a) an addition polymerized polynorbornene copolymer having norbornene-based monomeric units with pendent crosslinkable groups; and
b) a bismaleimide compound in an amount ranging from 5 to less than 80 weight percent based on a total weight of the curable components, wherein the bismaleimide compound has (1) two maleimido groups and (2) at least one C36 hydrocarbon group with 0 to 3 carbon-carbon double bonds; and
c) a thermal radical initiator.

2. The curable composition of claim 1, wherein the addition polymerized polynorbornene copolymer further comprises norbornene-based monomeric units with pendent alkyl groups, norbornene monomeric units without pendent groups, or a combination thereof.

3. The curable composition of claim 2, wherein the addition polymerized polynorbornene copolymer comprises 2 to 80 mole percent norbornene-based monomeric units with pendent crosslinkable groups, 20 to 90 mole percent norbornene-based monomeric units with pendent alkyl groups, and 0 to 30 mole percent norbornene monomeric units without pendent groups.

4. The curable composition of claim 1, wherein the norbornene-based monomeric units with pendent crosslinkable groups are derived from a monomer of Formula (I-A) or (I-B)

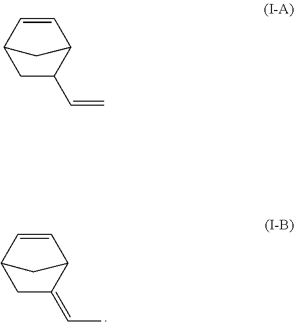

5. The curable composition of claim 1, wherein the monomeric units with pendent crosslinkable groups are derived from monomers of Formula (II) 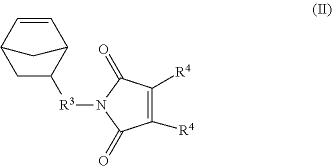
wherein
R³ can be a (hetero)hydrocarbylene group; and
each group R⁴ is hydrogen or methyl.

6. The curable composition of claim 1, wherein the bismaleimide compound is formed by reacting a C36 diamine having 0 to 3 carbon-carbon double bonds with maleic anhydride.

7. The curable composition of claim 1, wherein the bismaleimide compound has at least two C36 hydrocarbon groups with each having 0 to 3 carbon-carbon double bonds and being aliphatic.

8. The curable composition of claim 7, wherein the bismaleimide compound is formed by reacting a C36 diamine having 0 to 3 carbon-carbon double bonds with a dianhydride and then with maleic anhydride.

9. The curable composition of claim 7, wherein the bismaleimide compound is selected to be a compound of one of the following formulas 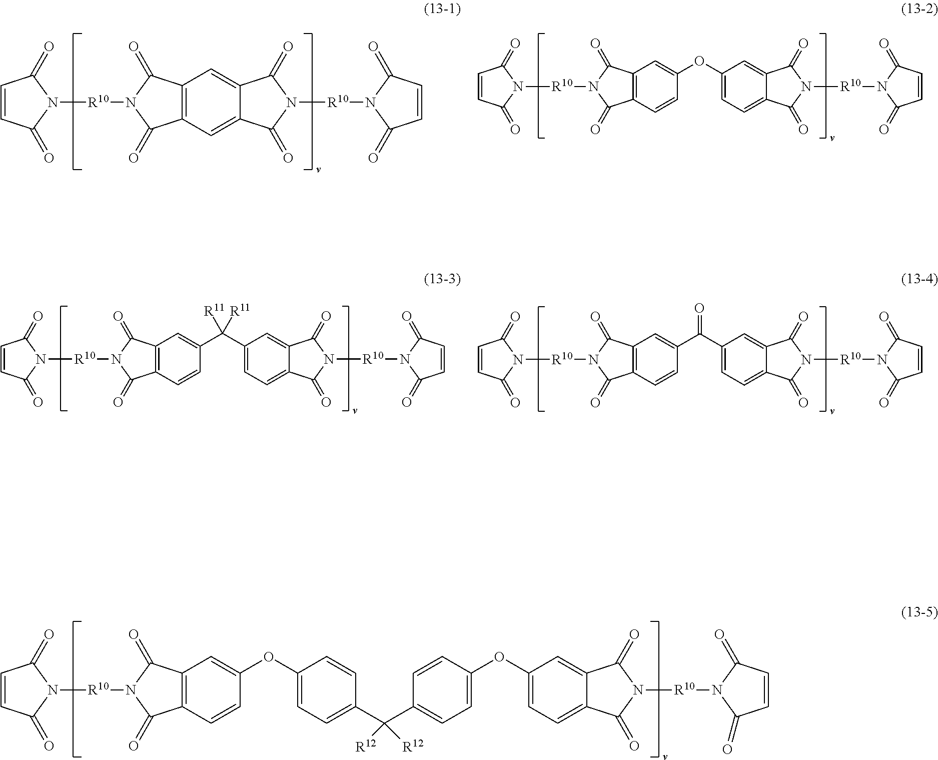
wherein
each R¹⁰ is a C36 group having 0 to 3 carbon-carbon double bonds;
each R¹¹ and R¹² is independently hydrogen, methyl, or trifluoromethyl; and
v is a number in a range of 1 to 10.

10. The curable composition of claim 1, wherein the curable composition is positioned as a layer adjacent to a substrate.

11. A cured composition comprising a cured reaction product of the curable composition of claim 1 after exposure to a temperature sufficient to activate the thermal initiator.

12. The cured composition of claim 11, wherein the cured composition has a glass transition temperature (Tg) greater than 110 degrees Celsius.

13. The cured composition of claim 11, wherein the cured composition has a dielectric constant less than 2.5 and/or a dielectric loss tangent less than 0.004 at 10 GHz.

14. The curable composition of claim 1, wherein the addition polymerized polynorbornene copolymer comprises less than 2 weight percent of a 1-alkene-based monomeric unit.

15. The curable composition of claim 1, wherein the addition polymerized polynorbornene copolymer consists of norbornene-based monomeric units.

16. The curable composition of claim 1, wherein the addition polymerized polynorbornene copolymer consists essentially of norbornene-based monomeric units.
